(19) United States
(12) Patent Application Publication
(10) Pub. No.: US 2019/0032341 A1
(43) Pub. Date: Jan. 31, 2019

(54) METHOD FOR MOUNTING WALL PANELS & WALL PANEL SYSTEM

(71) Applicant: RECO SURFACES LIMITED, Boston Lincolnshire (GB)

(72) Inventor: Charles Fleet, Boston Leicestershire (GB)

(21) Appl. No.: 16/072,972

(22) PCT Filed: Jan. 25, 2017
(86) PCT No.: PCT/GB2017/050191

§ 371 Date: Jul. 26, 2018

(30) Foreign Application Priority Data
Jan. 26, 2016 (GB) 1601435.9

(51) Int. Cl. E04F 13/08; E04F 13/18

(52) U.S. Cl. CPC E04F 13/0866; E04F 13/0885; B32B 27/08; E04F 13/18; B32B 2307/40; E04F 13/0898

(57) ABSTRACT

A method for mounting wall panels (1a,1b) to a wall (27). The method including providing first and having a thermoplastics substrate (3) and a protective film (7) applied over a major surface (11) of the substrate, said protective film (7) having a thickness of at least 140 μm and including a textured surface (17) having a multiplicity of micro-peaks and/or micro-troughs randomly arranged, thereby providing a light diffusing and/or light scattering effect; mounting the first and second laminated wall panels (1a,1b) onto the wall (27); and inserting a gap filling sealant (21) into a gap between adjacent peripheral portions (29a,29b) of the first and second wall panels (1a,1b). A wall panel system is also disclosed.

### CROSS-REFERENCE TO RELATED APPLICATIONS

The present application claims priority to PCT International Patent Application Serial No. PCT/GB2017/050191 filed Jan. 25, 2017 entitled “METHOD FOR MOUNTING WALL PANELS & WALL PANEL SYSTEM,” which claims the benefits of GB Patent Application Serial No. 1601435.9 filed Jan. 26, 2016, the entire disclosures of the applications being considered part of the disclosure of this application and hereby incorporated by reference.

### BACKGROUND OF THE INVENTION

### 1. Field of the Invention

The present invention relates to a method for mounting wall panels and a wall panel system.

### 2. Description of the Prior Art

Internal walls of buildings are paneled with a wide range of different materials in order to achieve the decorative effect and functionality required. Flat plastic sheets are often fitted as wall panels in areas where a decorative, easily cleanable surface is required. Typical examples are rigid sheets made from melamine formaldehyde or high pressure laminates, known by brand names such as Formica. Formica is a hard thermoset plastic material available in sheets having a thickness in the range 1 to 6 mm. The sheets can have a single colour or printed design.

Other sheets are made from PMMA (Acrylic), PMMA/ABS (Acrylic capped Acrylonitrile Butadiene Styrene), Polypropylene, Styrene or PVC. PMMA may be cast or extruded. The other materials are normally extruded as solid sheets. PVC can be extruded in multi-wall, hollow section design. These materials vary in both price and performance. Acrylic is normally sold as a high gloss wall panel, with good scratch resistance, but has poor fire resistance to surface spread of flames. The other materials are normally provided with a smooth satin finish. Only PVC has good fire resistance. All of the aforementioned materials can be coloured using pigments, or can be surface printed.

Resistance to scuffing, scratching, graffiti and chemicals differs according to the chemical composition and surface hardness of the materials. Melamine performs well on these counts and is also non-flammable, but as a thermoset cross-linked and rigid material is prone to damage at its edges. Furthermore, it cannot be recycled. The other extruded thermoplastic materials can be recycled provided they are not seriously contaminated by the mounting adhesive, dirt, etc. It is desirable to have a good resistance to scuffing and scratching, however a problem with wall panels made from the above mentioned materials that have a good resistance to scuffing and scratching tend to be relatively heavy and rigid. This means that the sheets have to be transported in a flat arrangement.

The wall panels described above are attached to a wall surface using an adhesive such as an acrylic adhesive, or a urethane adhesive. The dimensions of the sheets vary according to the application. Most panels are room height, typically 2.4 m and around 1 m wide. Thicker wall panels may be provided with tongue and groove edges to join two panels together.

Alternatively, a fitter may use H section profiles to join two panels together along their longitudinal edges. Thinner materials may be simply abutted together, or may be joined by H section profiles.

A problem with known types of joints is that they are clearly visible upon casual inspection, particularly when H-section profiles are used. For panels including a printed surface, use of H-section profiles to join adjacent panels together destroys the continuity of the printed matter across the wall panels, for example when a scenic view extends across several panels. Even when panels are simply abutted against one another, any unevenness in the wall surface clearly exposes the joint. This is exacerbated for areas of colour which are distinct from the colour of the backing material, for example for relatively dark areas of print when the backing material has a relatively light colouring. Of course, it will be appreciated that the printed layer may have areas of dark colouring and light colouring adjacent a joint and therefore it is not always possible to match the colour of the backing material to the colours of the printed layer along the joint.

Furthermore, when wall panels are cut by a fitter on site, at least one of the abutting edges may not be as straight as the manufactured edge. This can increase the visibility of the joint.

Wall panels may be used in wet areas such as bathrooms, for example around a shower or a bath, as an alternative to tiling. When using wall panels in wet areas it is important that any join between adjacent wall panels is watertight. This may be achieved by using a separate joining profile. One such join may comprise an aluminium or plastic extrusion having a generally right angled shape for use in corners or an “H” section for inline joints. Such joining profiles rely on the inherent elasticity/plasticity of the material forming the joining profile (i.e. the aluminium or plastic) to adapt to any variations in the wall panel thickness or the surface of the wall.

Conventional moulding or forming processes create slight variations in the thickness and contours of the wall panel. Further variation may be created when bonding layers together to create a panel and when panels are trimmed to achieve their target thickness. Plastered walls and walls in older buildings may also not be completely true, including portions which are not completely vertical or corners which do not join at exactly 90°.

Conventional joining profiles may not adapt well to such variations, resulting in formation of a seal which is not watertight.

There can also be difficulties in mounting conventional wall panels onto surfaces in a manner that provides a watertight seal. Typically wall panels are attached to the wall by a suitable adhesive applied to selective areas of the rear of the wall panel which adheres to both the wall panel and wall surface. Often it is necessary to use an adhesive that has good water resistance and gap filling ability in order to properly bond the panels to the wall. Typically the type of adhesives used take a long time to set. It is also difficult to obtain even application of adhesive along a panel edge, particularly when at least one of the panels is joined along a cut edge. When the edges of the panels are not firmly bonded to the wall, the edge of the wall panel may bow outwards slightly, which can give an unsightly finish and prevent a watertight seal from being achieved.

Accordingly, it is desirable to have a wall panel system and mounting method that achieves at least one of the following: provides a substantially seamless appearance to a casual observer; provides waterproof joints; provides wall panels having good scuff/scratch resistance; is easy to mount; is arranged to deal with uneven surfaces; and includes relatively flexible wall panels for ease of transportation.

### BRIEF SUMMARY OF THE INVENTION

Accordingly, the present invention seeks to mitigate at least one of the afore-mentioned problems, or at least to provide an alternative method and system to known methods and systems.

According to one aspect of the invention there is provided a method for mounting wall panels to a wall, said method including providing first and second laminated wall panels, each having a plastics substrate, and a protective film applied over a major surface of the substrate, said protective film including a textured surface; mounting the first and second laminated wall panels onto the wall; and inserting a gap filling sealant into a gap between adjacent peripheral portions of the first and second wall panels.

A significant advantage of the invention is that the visual appearance of the gap filling sealant, when in its set condition, substantially matches the visual appearance of the textured surface of the protective film. The sealant provides sufficient visual continuity between the protective film of the first wall panel and the protective film of the second wall panel that it is difficult for a casual observer to see the joint between the first and second wall panels.

Sealants are sold in various colours such as white, brown and clear. The skilled person will readily understand what is meant by a “clear” sealant. In preferred methods the sealant includes silicone. Silicone sealants are commercially available, such as Soudal Silirub 2 S Silicone Sealant.

The sealant can be non-opaque. The sealant can be substantially transparent and/or translucent. The sealant can have a slightly cloudy appearance. Since clear sealant has a slightly cloudy appearance, side edges of the wall panels are not easily visible through the sealant. This is so, even in the case where the wall is uneven.

Typically the sealant substantially fills the gap between the first and second wall panels.

In preferred embodiments the protective film is substantially transparent.

Advantageously the textured surface of the film has a light scattering and/or light diffusing effect. This helps to mask any unevenness in the wall and hide the joint between the first and second wall panels.

Advantageously the textured surface can be an embossed textured surface. The textured surface is formed by an embossing process. The embossing process has the effect of increasing the depth of the pre-textured film. For example, a film having a pre-textured thickness of around 120 μm, which is embossed to a height of 20 μm, will have a total thickness of around 140 μm.

The embossing process includes heating the film to soften it. The embossing process includes applying at least one roller to the film, for example be rolling the roller over the film or passing the film through a pair of rollers. At least one of the rollers includes a textured outer surface for treating the film. In preferred embodiments, the outer surface of the roller includes a granular texture. The granular texture is a fine texture similar to a fine, very fine or extra fine abrasive paper. The granular texture typically has an average grit size that is less than or equal to 100 μm, preferably less than or equal to 80 μm, and more preferably still less than or equal to 60 μm. The granular texture typically has an average grit size that is greater than or equal to 20 μm, preferably greater than or equal to 30 μm, and more preferably still greater than or equal to 40 μm.

Advantageously the textured surface comprises a random arrangement of micro-peaks and/or micro-troughs. This texture provides a good light diffusing and/or light scattering effect. This texture provides good scuff and scratch resistance. It also helps to make joins between panels less visible. The micro-peaks and/or micro-troughs provide a somewhat stippled appearance, having no discernible pattern.

Advantageously a surface gloss measurement of the textured surface is greater than or equal to 1GU, preferably greater than or equal to 1.5GU and more preferably greater than or equal to 2GU. Advantageously the surface gloss measurement of the textured surface is less than or equal to 20GU, preferably less than or equal to 18GU and more preferably less than or equal to 15GU, and more preferably still less than or equal to 12GU. A particularly preferred range is 2GU to 10GU. Having a low GU provides a satin finish which helps to hide joins between the panels.

Advantageously the texture extends across substantially the entire outer surface of the film. Advantageously the texture is applied in a fairly even manner across the film. That is, the density of the texture is relatively even across the film.

Advantageously the wall panel is arranged such that the textured surface is an outer surface. The textured surface faces away from the wall. The textured surface is the visible outer surface.

Advantageously at least one of the wall panels can include at least one image. For example, at least one of the wall panels can include at least one image printed on to a major surface thereof. The image can be printed onto at least one of: the film; the substrate and an intermediate layer such as an adhesive layer. The protective film is the outer layer of the wall panel and thus protects the wall panel. If an image is printed on to the film, it is printed on to an inner surface thereof. The substrate is typically the inner most layer. If the image is printed onto the substrate, it is printed on an outer surface thereof. The printed image is visible through the film.

Thus, in preferred embodiments, the wall panel comprises a laminated structure, which includes: the substrate as an inner layer, the protective film as an outer layer, and at least one printed image located between the protective film and the substrate. The textured surface faces outwards.

Preferably the wall panel is manufactured by applying the film to the substrate using a laminating machine, such that the textured surface faces outwards.

Advantageously the film can be attached to the substrate and/or printed image by means of a pressure sensitive adhesive, and preferably a solvent acrylic adhesive. Alternatively the film can be attached to the substrate and/or printed image by means heat during extrusion of the substrate.

Advantageously the film can include a thermoplastic such as PVC, PMMA and PVDF. The film preferably comprises a PVC film, such as a monomeric calendared PVC film. The film can have a laminated structure. For example, the film can include a first layer of PVC and a second layer of PMMA. Preferably the PMMA forms an outer layer.

Typically the film has a pre-textured thickness which is greater than or equal to 120 μm, preferably greater than or equal to 130 μm, and more preferably still is greater than or equal to 140 μm.

Typically the film has pre-textured thickness which is less than or equal to 200 μm, preferably less than or equal to 180 μm, and more preferably still is less than or equal to 160 μm.

Advantageously the texture height is greater or equal to 15 μm, preferably greater than or equal to 20 μm, and more preferably still is greater than or equal to 25 μm. Advantageously the height of the texture is less than or equal to 80 μm, preferably less than or equal to 70 μm, and more preferably is less than or equal to 60 μm, and more preferably still less than or equal to 50 μm. A particularly preferred range for the texture height is 25 μm to 70 μm. It has been found that a textured surface of random peaks and troughs having a texture height of 25 μm or over produces good rub resistance properties, as well as scattering and/or diffusing light. The texture height is the trough to peak height, typically the highest peak to the lowest trough along an axial profile of a sample tile cut from a wall panel. Typically this is measured by an optical profilometer. The profilometer produces a 3D profile of a localised area of the panel, and from that scan can produce a peak to trough profile along an axis, for example in the x or y directions. This is explained further in the specific embodiments.

The inventor has discovered that a particularly beneficial amount of light scattering is achieved when the height of the embossed texture is greater or equal to 25 μm.

Advantageously the average surface roughness of the textured surface is greater than or equal to 2 μm, is preferably greater than or equal to 2.5 μm, is more preferably greater than or equal to 3.0 μm and more preferably still is greater than or equal to 3.5 μm. Advantageously the average surface roughness of the textured surface is less than or equal to 12 μm, is preferably less than or equal to 11 μm, is more preferably less than or equal to 10 μm and more preferably still is less than or equal to 9 μm. A particularly preferred range is 3 μm to 9 μm. Average surface roughness is typically measured using an optical profilometer.

The nominal characteristics of the profilometer satisfy the requirements of BS EN ISO 25178-602: 2010. This is explained further in the specific embodiments.

A particularly preferred embodiment has a pre-textured thickness of around 150 μm, which is embossed to a height of 25 μm, giving a total thickness of around 175 μm.

Having a large film thickness is advantageous since it helps to obscure a side edge of the first and/or second wall panel. The overall thickness of the film is typically at least 140 μm, preferably at least 150 μm, more preferably at least 160 μm, and more preferably still at least 170 μm. The total thickness of the embossed textured film is typically less than or equal to 250 μm.

Advantageously the film can include a plasticizer, particularly PVC films. The plasticizer content is preferably greater than or equal to 15%, preferably greater than or equal to 17% and more preferably still greater than or equal to 18%. Plasticiser content is measured in parts per hundred of PVC resin. This provides the panel with good scuff and scratch resistance.

The plasticizer content which is preferably less than or equal to 25%, preferably less than or equal to 23% and more preferably still less than or equal to 21%. The inventor has found that having a plasticizer content in the range 18% to 21% provides a very good balance between film flexibility and scuff/scratch resistance, particularly in the context of PVC films. The lower the plasticizer content the harder, and hence more rigid, the film.

Advantageously the film has a density in the range 1.25 g/cm³ to 1.35 g/cm³, and is preferably in the range 1.27 g/cm³ to 1.32 g/cm³, and more preferably still is around 1.29 g/cm³. This provides the panel with good scuff and scratch resistance. This range is particularly suited to PVC films.

Advantageously the substrate for at least one of the first and second wall panels includes a thermoplastic. The thermoplastic preferably includes at least one of PVC and ABS. These materials are recyclable.

Advantageously the thickness of the substrate for at least one of the first and second wall panels is greater than or equal to 0.5 mm, and is preferably around 1 mm. Having a thin substrate enables the wall panel to be rolled-up, particularly when made from PVC, and counter rolled to remove any memory before fitting to a surface. It also provides a low weight wall panel. The material can be line bent without use of heat.

In preferred methods the thickness of the substrate for at least one of the first and second wall panels is less than or equal to 2 mm.

Advantageously at least one of the wall panels can be transported to an installation site in a rolled-up configuration. This saves on transportation cost. The method can include unrolling the wall panel prior to mounting on the wall.

Advantageously the method includes applying double-sided adhesive tape or film to at least one of the wall and the wall panels. Mounting the first and second wall panels to the wall preferably includes mounting a peripheral portion of the first wall panel onto the double-sided adhesive tape or film and mounting a peripheral portion of the second wall panel onto the double-sided adhesive tape of film, such that the peripheral portions are located adjacent to one another.

Advantageously the method includes bonding a backing member, such as a backing strip, to at least one of the wall and the wall panels. Preferably the backing member is bonded to the wall. The backing member is arranged to support at least one of the first and second wall panels. The backing member is located behind the joint. The backing member runs along substantially the full length of the wall panels. The backing member is used for non-smooth walls, such as brick or block work walls.

Advantageously the method includes applying double-sided adhesive tape or film to the backing strip. Mounting the first and second wall panels to the wall includes mounting a peripheral portion of the first wall panel onto the double-sided adhesive tape or film; mounting a peripheral portion of the second wall panel onto the double-sided adhesive tape of film, such that the peripheral portions are located adjacent to one another.

The double-sided adhesive tape or film is preferably substantially transparent or translucent.

It has been found that a double-sided adhesive tape having at least one of the following characteristics is particularly suited for this application: a static shear adhesion at 23° C. 1 kg/625 mm² of at least 4000 minutes, preferably at least 4500 minutes and more preferably still of at least 5000 minutes; a static shear adhesion at 70° C. 0.5 kg/625 mm² of at least 500 minutes, preferably at least 550 minutes, and more preferably still at least 600 minutes; and a tack AFERA 4015 characteristic of at least 3.0N/25 mm, preferably at least 3.5N/25 mm and more preferably still at least 4.0N/25 mm.

Advantageously the method includes using a tool, such as a roller, to press at least one of the first and second wall panels against the double-sided adhesive tape or film. This is to ensure that the or each wall panel bonds along its full length with the double-sided adhesive tape or film.

According to another aspect of the invention there is provided a wall panel system including: at least first and second laminated wall panels, each having a plastics substrate and a protective film applied over a major surface of the substrate, said protective film including a textured surface; and a gap filling sealant for filling a gap between adjacent peripheral portions of the first and second wall panels.

Advantageously each of the wall panels can be arranged according to any configuration described herein.

In a particularly preferred embodiment, the textured surface includes a multiplicity of micro-peaks and/or micro-troughs randomly arranged to provide a light diffusing and/or light scattering effect.

The thickness of the film is preferably at least 140 μm.

Advantageously at least one of the wall panels is sufficiently flexible to enable it to be manipulated into a rolled-up configuration.

Advantageously the system can include binding means for holding the wall panel in the rolled-up configuration. The binding means can include at least one tie and/or tubing, into which the wall panel can be inserted.

Advantageously the system can include double-sided adhesive tape or film.

Advantageously the double-sided adhesive tape or film can be substantially transparent or translucent.

Advantageously the double-sided tape or film can have a static shear adhesion at 23° C. 1 kg/625 mm² of at least 4000 minutes, preferably at least 4500 minutes and more preferably still of at least 5000 minutes.

Advantageously the double-sided tape or film can have a static shear adhesion at 70° C. 0.5 kg/625 mm² of at least 500 minutes, preferably at least 550 minutes, and more preferably still at least 600 minutes.

Advantageously the double-sided tape or film can have a tack AFERA 4015 characteristic of at least 3.0N/25 mm, preferably at least 3.5N/25 mm and more preferably still at least 4.0N/25 mm.

Advantageously the system can include a tool, such as a roller, to press at least one of the first and second wall panels against the double-sided adhesive tape or film.

Advantageously the system can include at least one a backing strip and an adhesive for boding the or each backing strip to the wall.

According to another aspect of the invention there is provided a method for mounting wall panels to a wall, said method including providing first and second laminated wall panels, each having a thermoplastics substrate and a protective film applied over a major surface of the substrate, said protective film including a textured surface arranged to scatter and/or diffuse light; mounting the first and second laminated wall panels onto the wall; and inserting a gap filling sealant into a gap between adjacent peripheral portions of the first and second wall panels. Advantageously the appearance of the sealant substantially matches the appearance of the protective film. Advantageously the textured surface includes a multiplicity of micro peaks and/or micro-troughs randomly arranged.

According to another aspect of the invention there is provided a wall panel system including: at least first and second laminated wall panels, each having a thermoplastics substrate and a protective film applied over a major surface of the substrate, said protective film including a textured surface arranged to scatter and/or diffuse light; and a gap filling sealant for filling a gap between adjacent peripheral portions of the first and second wall panels. Advantageously the appearance of the sealant substantially matches the appearance of the protective film. Advantageously the textured surface includes a multiplicity of micro peaks and/or micro-troughs randomly arranged.

### BRIEF DESCRIPTION OF THE DRAWINGS

An embodiment of the invention will now be described by way of example only with reference to the accompanying drawings in which:

FIG. 1 is a cross-sectional view of a wall panel used in a method and system in accordance with the invention;

FIG. 2 is an enlarged isometric view of the wall panel of FIG. 1, showing part of a textured outer surface of the wall panel, partly peeled back for illustrative purposes;

FIG. 3 is a diagrammatic cross-sectional view of part of a film which forms the textured outer surface of the wall panel, together with a layer of adhesive, the section line being shown in FIG. 2;

FIG. 4 shows images of a prior art wall panel surface profile, for comparison with FIGS. 5 and 6;

FIGS. 5 and 6 are surface profiles of wall panels in accordance with the invention, in particular surface profiles of a textured outer surface of the wall panels;

FIG. 7 is a diagrammatic cross-sectional view of two wall panels similar to that shown in FIG. 1 mounted on an even surface;

FIG. 8 is a diagrammatic cross-sectional view of two wall panels similar to that shown in FIG. 1 mounted on an uneven surface; and

FIG. 9 is a diagrammatic cross-sectional view of two wall panels similar to that shown in FIG. 1 mounted on a surface, and using a backing strip seated behind adjoining edges of the wall panels.

### DETAILED DESCRIPTION OF THE INVENTION

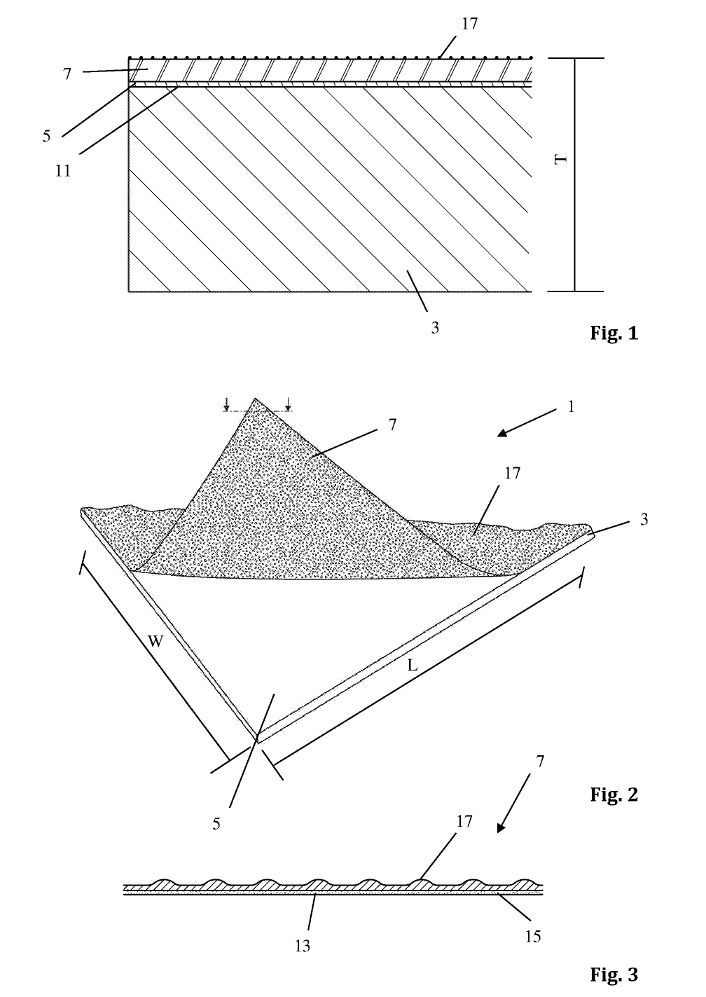

FIG. 1 shows a diagrammatic cross-sectional view of a wall panel 1 used in a wall panel system and method according to the invention.

The wall panel 1 has a laminated structure. The wall panel 1 includes a base (substrate) layer 3, optionally a printed layer 5, and a protective film 7.

The base layer 3 comprises a sheet of thermoplastics material, such as a sheet of PVC (Polyvinyl chloride). The base layer 3 has a thickness T, which is typically in the range 1 mm to 2 mm. The base layer 3 has a length L, which is typically in the range 1.5 m to 3 m. The base layer 3 has a width W, which is typically in the range 0.5 m to 1.5 m. The density of the base layer is typically around 1.4 g/cm³. Typically, the base layer 3 is opaque.

Optionally, at least one image 5 can be printed onto a major surface 11 of the base layer. For example, the image can cover a substantial portion of the major surface, or even the entire major surface 11. Alternatively at least one discrete images 11 can be printed on the major surface, for example in the form of a pattern. In some arrangements, the image 11 can be split across a plurality of wall panels 1, for example when depicting a panoramic or scenic view. Typically, the base layer 3 is coloured white when at least one image is printed there on.

The protective film 7 overlies the major surface 11 of the base layer, and any images 5 formed thereon. The film 7 is bonded to the major surface 11 of the base layer and/or the image(s) 5 by a pressure sensitive adhesive 13. The adhesive 13 bonds an inner surface 15 of the film to the major surface 11 of the base layer and/or the image(s) 5. The inventor has discovered that a pressure sensitive solvent acrylic adhesive is well suited to this function. This type of adhesive fixes the position of the film 7 relative to the base layer 3. In tests, the inventor found that when water based acrylic adhesives were used, there was a tendency for the film 7 to move somewhat relative to the base layer 3, in particular to shrink inwards from the edges of the base layer, which is highly undesirable. Furthermore the adhesive 13 is sufficiently strong to allow the wall panel to be cut using a fine tooth hand saw, a circular saw or jig saw, without lifting the film at its edge. The adhesion remains effective against hot water at normal shower temperature and heat from a towel rail set at not less than 30 mm from the wall surface.

The film 7 is made from PVC. Preferably the film 7 is a monomeric calendared PVC film. The film 7 includes a plasticizer content which is in the range 15% to 25%, and preferably in the range 18% to 21%. Plasticiser content is measured in parts per hundred of PVC resin. The plasticizer content is an important part of the invention since it has a significant impact on the hardness of the film, and hence the ability of the wall panel 1 to resist scuffing and scratching in use. The range has been specifically chosen to balance the ease of application of the film to the wall panel and the surface hardness of the finished product. The film 7 has a density in the range 1.25 g/cm³ to 1.35 g/cm³, and is preferably around 1.29 g/cm³. This also has an impact on scuff and scratch resistance.

The film 7 has a textured outer surface 17. The textured surface 17 is formed by an embossing process.

The film 7 preferably has a pre-textured thickness in the range 120 μm to 200 μm (excluding the thickness of the adhesive layer 13—the adhesive layer 13 typically adds a few microns of thickness). A particularly preferred pre-textured thickness is around 150 μm.

The embossing process includes heating the film 7 to soften it, and rolling at least one roller (not shown) over the film 7, or passing the film 7 through a pair of rollers (not shown). At least one of the rollers includes a textured outer surface for treating the outer surface 17 of the film. The outer surface of the roller includes a granular texture. The granular texture preferably has a fine texture similar to a fine, very fine or extra fine abrasive paper, such as a silicone carbide paper, for example according to ISO 6344/FEPA Grit designation. The granular texture typically has an average grit size in the range 100 μm to 20 μm, and preferably in the range 60 to 30 μm. The textured surface 17 produced in the film is a fine stipple-like texture 17. The texture 17 extends across substantially the entire outer surface of the film, in a fairly even manner. That is, the density of the texture is relatively even across the film. The stippled texture 17 has no discernible pattern. It is essentially a random arrangement of micro-peaks and micro-troughs.

The height of the embossed texture 17, for example from its highest peak to its lowest trough, is typically in the range 15 km to 80 μm, and is preferably around 25 μm to 40 μm. Thus the overall thickness of the textured film is typically in the range 135 μm to 280 μm. A particularly preferred example has a pre-textured thickness of around 150 μm, and an embossed texture thickness of around 25 μm, giving the textured film a thickness of around 175 μm.

The film 7 is manufactured with the adhesive 13. The wall panel 1 is manufactured by applying the film 7 to the base layer 3 by means of a laminating machine. This machine applies the required heat and pressure to achieve a strong bond between the film 7 and base layer 3 and/or printed images 5. The adhesive 13 layer adds slightly to the combined thickness of the base 3 and film 7.

A significant advantage of the textured surface 17 is that is has good light diffusing and/or light scattering properties. Together with the transparency of the film this creates a satin rather than a gloss or matt surface. The effect of the texture 17 and thickness of the film 7 makes wall unevenness less visible, and helps to hide joins between panels when mounted in the manner described below. The texture 17 also helps to prevent scratching and scuffing occurring. When scratching and/or scuffing occurs, the texture 17 means that it is less visible to the casual observer.

A further advantage of the textured film 7 is its resistance to scuffing and scratching. This is demonstrated by the results of a rubbing test shown below, which compares a wall panel according to the invention with known wall panels.

Comparative Testing

Rub Test

A Satra STM 462 rub tester was used to compare the above described inventive material to others. The tests were conducted using a loading pressure of 5 psi and a pad pre-soaked in abrasive paste with a six micron particle size, to replicate cleaning materials. The materials tested were graded from 1 showing ‘severe damage or colour transfer’ to 5 showing ‘no damage or colour transfer’. The results in Table 1 below are based on the average values determined from 3 replicate tests.

TABLE 1

| Wall Panel Material | 50 Rubs | 100 Rubs | 200 Rubs | 500 Rubs |
|---|---|---|---|---|
| Melamine Gloss (Prior Art) | 4-5 | 4 | 3 | 2 |
| Melamine Matt (Prior Art) | 4-5 | 4-5 | 4 | 3 |
| PVC Satin (Prior Art) | 4 | 3 | 2 | 2 |
| Acrylic Gloss (Prior Art) | 3-4 | 3 | 2 | 1 |
| Wall panel according to the | 5 | 5 | 4-5 | 4-5 |
| invention | | | | |

The fine and even textured surface 17 has other advantages compared to a smooth surface. Firstly it conceals dust, light scratching and marks, which are clearly visible on a smooth and particularly a smooth gloss surface. Secondly it is fine enough to make surface contaminants and the cleaners used to remove them, easily removable by rinsing and wiping with water. Graffiti spray paint can be removed with white spirit or specialist cleaners. Fine scratches can be removed by use of multi surface polish.

The combination of surface hardness and the fine and even emboss makes the surface resistant to scuff and scratch. Scotch® type abrasive pads and abrasive cleaners can therefore be used to clean the wall panel 1.

Optionally, UV protecting additives can be included in the film 7 to improve resistance of the base layer 3 and the printed image 5 to the effect of sunlight. This helps to prevent discolouration of the printed images 5 and/or the base layer 3.

Surface Roughness (Ra)

The surface roughness of two samples of the invention was determined and compared with a conventional satin PVC wall panel. The surface roughness of the textured surface was determined using a Proscan 2000A optical profilometer fitted with a confocal probe, having a Z-direction measuring range of 400 μm and a resolution of 22 nm. The nominal characteristics of the system satisfy the requirements of BS EN ISO 25178-602: 2010. Two sample tiles (a) and (b) of each wall panel were used for the test.

The average roughness amplitude (Ra) was determined on the textured surface of the sample.

Five replicate determinations were made on individual samples in both directions over a prescribed length using the following test parameters:

Panel 1 (Prior Art Satin PVC Wall Panel):

Scan length=4 mm; Step interval=0.003 mm; Surface filter=99; Roughness filter=0.8 mm.

Panels 2 and 3 (Samples of Wall Panels in Accordance with the Invention):

Scan length=12.5 mm; Step interval=0.008 mm; Surface filter=99; Roughness filter=2.5 mm.

The results are shown in Table 2 below.

TABLE 2

| Average Roughness, Ra (μm) | | |
|---|---|---|
| Panel 1 | Panel 2 | Panel 3 |
| (prior art) | (invention) | (invention) |

| Replicate | X | Y | X | Y | X | Y |
|---|---|---|---|---|---|---|
| 1 | 0.30 | 0.22 | 7.14 | 9.24 | 3.56 | 3.72 |
| 2 | 0.24 | 0.20 | 6.78 | 6.68 | 4.56 | 3.96 |
| 3 | 0.27 | 0.21 | 5.93 | 8.39 | 3.40 | 4.17 |
| 4 | 0.40 | 0.26 | 8.13 | 8.09 | 5.75 | 5.40 |
| 5 | 0.30 | 0.23 | 7.35 | 7.92 | 5.14 | 4.10 |
| 6 | 0.24 | 0.21 | 8.15 | 8.33 | 4.33 | 4.33 |
| Mean | 0.29 | 0.22 | 7.23 | 8.11 | 4.46 | 4.28 |
| Std. dev. | 0.06 | 0.02 | 0.82 | 0.83 | 0.90 | 0.59 |

The X measurements were taken parallel with the short edge of the individual replicate tiles and Y measurements parallel with the long edge. The replicate measurements 1-3 were taken from the first tile (a) and measurements 4 to 6 from the other tile (b).

It can be seen from the results above that the panels according to the invention have a surface texture having an average surface roughness that is 15 to 36 times greater than the average surface roughness of a conventional non-textured wall panel.

3D Surface Profile

In addition to the above, a 3D profile of the surface was acquired using the same profilometer used for the roughness measurements over a 5 mm×5 mm area of the tile at a 0.01 mm step interval. The profile is shown with no applied filter.

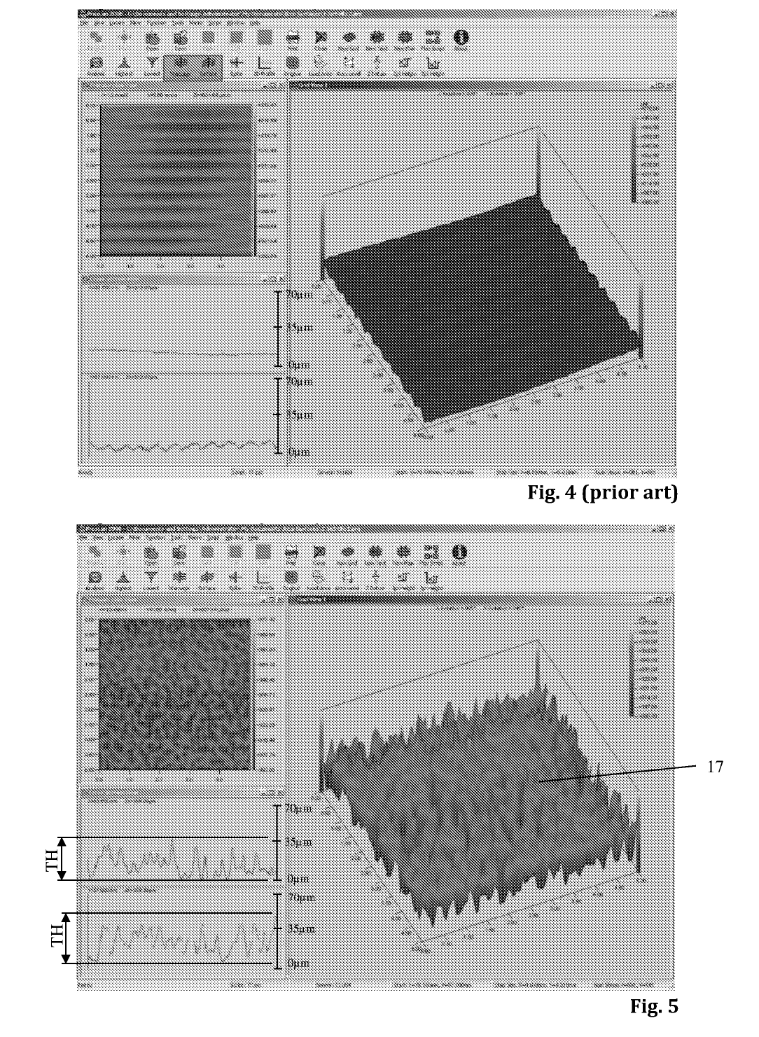

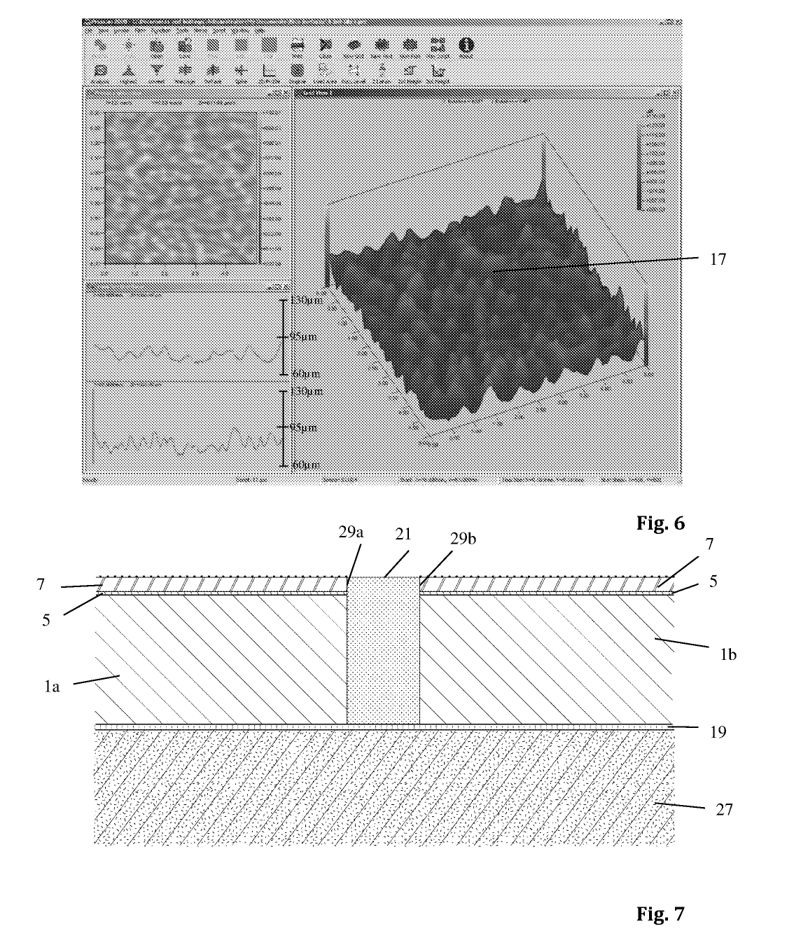

The results of the 3D profiles can be seen in FIGS. 4 to 6. FIG. 4 shows the 3D profile of a prior art non-textured satin PVC wall panel. FIGS. 5 and 6 show 3D profiles of two samples of the invention. It is clear from FIGS. 5 and 6 that the textured surface comprises a random arrangement of micro-peaks and micro-troughs. The random micro-peaks and micro-troughs are distributed across the textured film 7, in a dense arrangement, which contrasts with conventional non-textured panel. The texture profile, which is a measure of the height of each trough and the depth of each peak, is shown by way of a scale in the 3D images.

The X and Y cross-sectional profiles of the texture (bottom left images in FIGS. 4 to 6) represent the micro-peaks and micro-troughs along the cross-sections in the X and Y axes respectively at the X and Y values indicated. The vertical bars at the left and right side of the graphs represent the vertical scales shown in the 3D images. The X and Y values mentioned above the X and Y direction profiles respectively indicate the X and Y values at which each profile is taken. The Z values mentioned above the X and Y direction profiles indicate the vertical height at which the profile meets the vertical bar at the left or right side of the graph. Thus the X and Y direction profiles are representative micro-peak and micro-trough profiles from the corresponding 3D image. The texture height TH, is shown in FIG. 5 in relation to the X and Y direction profiles across the 5 mm by 5 mm samples, as a measure of the maximum peak to the lowest trough along the profile for the sample.

The images in the top left hand corners of FIGS. 4 to 6 are plan views of the respective 3D images.

In FIG. 4, the vertical Z scale extends from 0 μm to +70 μm. However it can be seen from the X and Y profiles, and the 3D image, that the surface of the prior art wall panel is not random, but rather has a sinusoidal pattern in the Y direction, and no discernible pattern at all in the X direction. The pattern (texture) height is approximately 7 μm.

In FIG. 5, the vertical Z scale extends from 0 μm to +70 μm. It can be seen from the X and Y cross-sectional profiles, and the 3D image, that the textured surface of the wall panel according to the invention comprises a dense arrangement of micro-peaks and micro-troughs, randomly arranged across the surface. The texture height is approximately 47 μm in one direction and 43 μm in the other direction.

In FIG. 6, the vertical Z scale extends from +60 μm to +130 μm. It can be seen from the X and Y cross-sectional profiles, and the 3D image, that the textured surface of the wall panel according to the invention comprises a dense arrangement of micro-peaks and micro-troughs, randomly arranged across the surface. The texture height is approximately 27 μm, in one direction and 20 μm in the other direction.

With regard to the density of texture, there are typically between 10 and 25 distinct peaks identified by the profilometer along each axial cross-sectional profile over a 5 mm by 5 mm sample tile. This gives a peak density of around 100 to 625 identifiable peaks in a 5 mm by 5 mm area. Of course, this is not a strict limit to the invention, but provides an approximate indication of the level of peak density, together with texture height, that a wall panel according to the invention has.

Surface Gloss

The surface gloss/reflectance of wall panel 1 (prior art) and panels 2 and 3 (invention) were measured at an angle of 85° using a Sheen tri-microgloss instrument. Two samples, Tile A & Tile B, of each wall panel were tested. Ten replicate areas were measured on each individual tile sample within the flat panel surface (excluding any join areas). The results are shown in Table 3 below.

Measurements using an angle of 85° are recommended for surfaces with a gloss measurement of <30 units when measured at 60°. However all surfaces were measured at the same angle to enable direct comparison. The results are shown in Table 3 below.

TABLE 3

| | Surface Gloss Measurements 85° | | | | | |
|---|---|---|---|---|---|---|
| | Panel 1 | | Panel 2 | | Panel 3 | |
| | (prior art) | | (invention) | | (invention) | |
| Replicate | Tile A | Tile B | Tile A | Tile B | Tile A | Tile B |
| 1 | 93.90 | 97.60 | 5.70 | 4.20 | 19.90 | 13.90 |
| 2 | 97.00 | 90.50 | 4.90 | 4.70 | 20.90 | 10.70 |
| 3 | 97.40 | 94.70 | 4.80 | 5.60 | 16.00 | 11.50 |
| 4 | 95.50 | 97.50 | 5.60 | 4.70 | 16.40 | 13.30 |
| 5 | 96.30 | 96.60 | 4.90 | 4.90 | 17.80 | 11.50 |
| 6 | 95.70 | 97.00 | 4.50 | 5.30 | 14.60 | 11.0 |
| 7 | 97.40 | 96.70 | 3.40 | 6.10 | 15.40 | 8.50 |
| 8 | 98.80 | 97.90 | 4.90 | 4.70 | 14.40 | 13.60 |
| 9 | 98.60 | 98.60 | 4.00 | 5.20 | 15.40 | 10.50 |
| 10 | 95.90 | 96.30 | 3.00 | 6.20 | 15.20 | 9.40 |
| Mean | 96.65 | 96.30 | 4.50 | 5.20 | 16.60 | 11.40 |
| Std. dev. | 1.50 | 2.31 | 0.87 | 0.65 | 2.23 | 1.78 |

It can be seen from the table that the prior art satin wall panel has a significantly higher gloss value than panels according to the invention. This shows that the random micro-peaks and micro-troughs tend to scatter and/or diffuse light falling up on them. Typically wall panels according to the invention have gloss values in the range 1.0GU to 20GU, and preferably in the range 2.0GU to 17GU.

### Example

A preferred form of the wall panel 1 is arranged as follows: a PVC base layer 3 having a thickness of around 1000 μm, optional printed layer 5, and protective textured film 7 having a thickness of around 175 μm. Thus the total thickness of the wall panel is approximately 1.2 mm.

It has been found that this has arrangement has further advantages compared with prior art wall panels comprising solid sheet materials having thicknesses of around 2.0 mm to 2.5 mm. For example:
1) Non-level walls and joins between panels are not noticeable on casual examination when the wall panels 1 are mounted in accordance with the method described below.
2) The wall panel 1 weight is approximately half the weight of the prior art panels, which makes:
   A) It much easier to position the wall panel 1 accurately when fitting, the task can be achieved by one person rather than requiring two people, and the adhesive has less weight to support.
   B) The wall panel 1 is much more flexible and enables it to be rolled into a tube for packing and transportation. This is not practical with 2 mm thick material because of the extra rigidity. 2 mm sheet materials typically weigh 9 kg in the normal sheet size of 1220×2440 mm. They can only be packed flat. Because of the weight and large size, which makes it difficult to handle, the sheet has to be protected with expensive protective packaging. This in turn adds up to a further kg. The length and width of the pack means it is difficult to handle and is easily dropped. It cannot be collected by the customer from store and has to be delivered direct to the point of installation. This adds further cost.
      The 1.2 mm wall panel 1 according to the invention can be rolled for transportation, preferably with the film and print facing inwards. The wall panel 1 can be secured at a diameter, which is not so tight as to impart a permanent memory to the wall panel 1. It has been found that a diameter of approximately 30 mm for a 2440 mm long wall panel 1 does not impart permanent memory. No expensive packaging or carriage arrangement is then required.
   C) Substantial cost saving in terms of the base sheet, packaging and carriage.
3) The wall panel 1 can be line bent to form corners without the use of heat or special equipment required for 2 mm panels. This can simplify fitting and eliminate the need for edging strips around windows and at external corners.
4) It achieves a Class 1 Rating for surface spread of flame under BS 476 Part 7, compared to Class 2 for a 2 mm panel, using the same adhesion method. The improved rating makes it suitable for more demanding areas within a building.

The wall panel system further includes means for mounting wall panels 1 to a wall in accordance with the method described below. The means for mounting wall panels 1 to a wall includes double-sided adhesive tape 19 and gap filling sealant 21, typically a clear silicone gap filling sealant. Optionally, the wall panel system can include backing members, preferably in the form of backing strips 23, and/or an MS (silyl modified polyether) adhesive 25, or similar adhesive.

The double-sided adhesive tape 19 is a high-tack, high strength, tape which has been designed to provide a watertight joint, by strongly gripping onto the wall 27 and the panel 1.

The tape 19 can include a carrier layer that is water resistant, which helps to ensure that the joint is watertight. For example, the carrier layer can comprise a plastics material, and is preferably made from Polyester. The adhesive is a high performance solvent acrylic adhesive suitable for demanding applications, giving very good low and elevated temperatures. It has good resistance to chemicals and UV light.

Typical characteristics of the tape are as follows:

Tape thickness APERA 4006: 0.07 mm

Colour: Clear

Carrier material: 12 Micron Polyester

180° Peel Adhesion AFERA 4001 10 Min: 10.7 N/25 mm

180° Peel adhesion AFERA 4001 24 hrs: 14.2 N/25 mm

Dynamic shear adhesion ASTM D-1200 10 mins: 108 N/625 mm²

Static shear adhesion 23° C. 1 kg/625 mm²: 5500 Minutes

Static shear adhesion 70° C. 0.5 kg/625 mm²: 700 Minutes

Tack AFERA 4015: 4.60N/25 mm

Temperature resistance: −30° C. to 160° C.

The backing strip 23 comprises a plastics or aluminium strip. The strip typically has dimensions in following ranges: width—40 mm to 100 mm, a depth—0.5 to 3 mm, and length—to match the length of the wall panels 1a,1b. A particularly preferred backing strip 23 has a width of between 50 mm and 100 mm, a depth of around 2 mm and is made from a non-plasticised PVC material. The PVC material has a density of around 1.4 g/cm³. It has been found that this type of backing strip 23 provides the required rigidity, but is relatively light and easy to handle. Tests have shown that the PVC strip 23 provides sufficient rigidity to achieve level joints, even when mounted onto brick or block work, and having a 1175 mm thick wall panel 1 mounted thereon. If the backing strip is too flexible it does not give the required support for this application. Aluminium or other thin semi rigid or rigid material could also be used for the strip.

A method of mounting wall panels 1 on a wall will now be described with reference to FIGS. 7 to 9.

FIG. 7 illustrates mounting first and second wall panels 1a,1b to a level and smooth wall 27, such as plaster board or MDF panel. A fitter applies a strip of double-sided adhesive tape 19 to the wall 27 at a location where first longitudinal edges 29a,29b of the first and second wall panels are to be positioned side by side. Typically, the strip of double-sided tape 19 is arranged substantially vertically on the wall, and is arranged to run along substantially the full length of the edges 29a,29b of the wall panels. Additional strips of double-sided adhesive tape 19 can be applied to the wall 27 in the vicinity of other edges of the first and second wall panels 1a,1b to ensure all edges are firmly bonded to the wall 27, and/or in the vicinity of edges of at least one additional wall panel. Typically each strip of tape 19 is oriented substantially vertically or horizontally on the wall 27. In some applications, strips of double-sided adhesive tape 19 can be located on the wall 27 in the vicinity of central portions of the first and second wall panels 1a,1b. The use of double-sided adhesive tape ensures that the bond thickness is substantially uniform, where used.

Typically adhesive 25 is not used in this context since its thickness cannot be precisely controlled.

Optionally, the tape 19 can include a guide line, which is located centrally and runs longitudinally along the tape to aid positioning of the wall panels. The guide line can be manufactured into the tape 19, or can be applied by the fitter. Additionally, or alternatively, the guide line can be applied to the wall surface. Turning back a short length of a protective cover from the top and bottom of the tape reveals the line marked on the wall.

The first wall panel 1a is mounted on the wall 27 such that the first edge 29a adheres to the strip of double-sided adhesive tape 19 along the full length of the wall panel. If available, the guideline is used to position the edge 29a of the first panel 1a. The second wall panel 1b is mounted on the wall 27 such that the first edge 29b adheres to the strip of double-sided adhesive tape 19 along the full length of the wall panel 1b. Thus the edges 29a,29b are arranged substantially parallel to one another, typically with a small gap in between. The gap is typically in the range 0.1 mm to 1.2 mm, for example in the range 0.4 mm to 1.0 mm. The gap may vary a little along the edges 29a,29b, for example if at least one edge 29a,29b has been cut by the fitter, manufacturing tolerances and/or mounting tolerances. Ideally the gap should be minimised to hide the joint.

A roller with a hard surface is preferably used to apply pressure to both adjoining edges 29a,29b in order to ensure that they are firmly adhered to the double-sided tape 19 and are level with each other.

A bead of sealant 21 is applied along the tape 19 to fill the gap between the wall panels.

The sealant 21 is immediately smoothed off, for example by wiping with at a cloth, tool or finger to improve the outer appearance.

The process is repeated for each additional joint that is required.

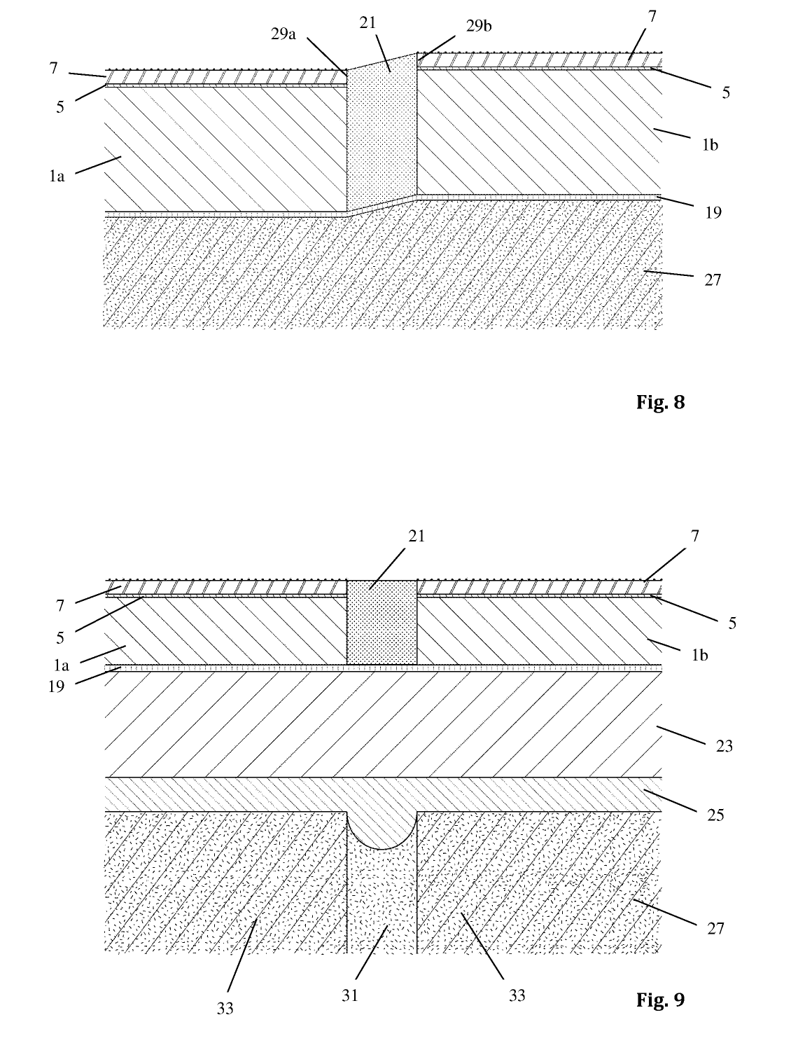

FIG. 8 illustrates the first and second wall panels 1a, 1b mounted onto an uneven wall in a similar manner to that described for FIG. 4.

FIG. 9 illustrates a modified method for mounting wall panels 1a,1b to a non-smooth wall 27, for example a brick wall. In the arrangement shown, a layer of adhesive 25 is applied to the wall to fill any gaps where mortar 31 sits between bricks 33. A backing strip 23 is then bonded to the wall 27 using the adhesive 25. The backing strip 23 runs longitudinally behind the joint. Double-sided tape 19 is applied to the backing strip along the length of the joint and wall panels 1a,1b are mounted on the wall 27 by bonding edges 29a,29b to the adhesive tape. Sealant 21 is applied in the gap between the wall panels 1a,ab. The sealant 21 substantially fills the gap.

The process is repeated for each additional joint required.

In each case, when the sealant 21 sets, it prevents the ingress of water into the joint. It is has a similar visual appearance to the textured surface 17 of the film, which makes the joint more difficult to see the joint. The slightly cloudy appearance of the clear sealant helps to obscure the base layer 3 from casual observation.

Furthermore the thickness of surface film is important particularly where a printed surface is involved. The print will normally be applied to a base layer 3, which is coloured white. The edge 29a,29b of the white base layer 3 will be visible if any gap is left between abutting panels 1a,1b. For this reason it is desirable that both panel edges 29a,29b should be as straight as possible and pushed as closely together as possible. They should also be the same height where possible (see FIG. 7). If there is a variation in height greater than the thickness of the clear top layer, even if the edges are perfectly abutted, white will show, highlighting the join. (FIG. 8).

To mitigate this problem, it is beneficial to use a thicker film 7 than prior art films since the margin of error for avoiding this problem is increased significantly. This is illustrated in Table 4 below.

TABLE 4

| | Film | | Margin For |
|---|---|---|---|
| Base Layer | Thickness | Total | Error (%) |
| Thickness (BLT) | (FT) | Thickness | (FT/BLT)*100 |
| 2000 μm (Prior Art) | 60 | 2060 | 3 |
| 2000 μm (Prior Art) | 100 | 2100 | 5 |
| 2000 μm (Invention) | 175 | 2175 | 8.8 |
| 1000 μm (Invention) | 175 | 1175 | 17.5 |

It can be seen from Table 4 above that applying the film 7 to a thinner base layer 3 increases the margin for error in concealing the white edges 29a,29b of the base layer 3. It also allows a fractionally larger gap between the wall panel edges 29a,29b before the white base layer 3 is visible.

The overall effect of the wall panel system is to provide wall panels 1a, 1b where the joins between panels are substantially undetectable by the casual viewer.

It will be appreciated by the skilled person that the invention is not limited to the described embodiments and includes variations which are within the scope of the appended claims. For example, the base layer 3 can be made from other thermoplastics such as ABS (Acrylonitrile Butadiene Styrene). While ABS is not as fire retardant as PVC, by laminating a PVC film to the ABS the flammability and surface spread of flame is reduced.

The protective film 7 can have a laminated structure. For example, the film 7 can comprise an inner PVC layer and an outer polymethyl methacrylate (PMMA) layer. PMMA is often referred to as acrylic. In one example, the PVC layer can have a thickness of around 240 μm, and the acrylic layer can have a thickness of around 60 μm, giving a total thickness of around 300 μm.

The protective film 7 can be made from polyvinylidene fluoride (PVDF).

Additionally, or alternatively, an image can be printed on to the film 7.

Additionally, or alternatively, an image can be printed on to the adhesive layer.

What is claimed is:

1. A method for mounting wall panels to a wall, said method including, providing: first and second laminated wall panels, each having a thermoplastics substrate and a protective film applied over a major surface of the substrate, said protective film having a thickness of at least 140 μm, and said protective film having a textured surface including a multiplicity of micro-peaks and/or micro-troughs randomly arranged, thereby providing a light diffusing and/or light scattering effect; mounting the first and second laminated wall panels onto the wall; and inserting a gap filling sealant into a gap between adjacent peripheral portions of the first and second wall panels.

2. A method according to claim 1, wherein the textured surface is an embossed textured surface.

3. A method according to claim 1, wherein the textured surface is an outer surface of the wall panel.

4. A method according to claim 1, wherein the visual appearance of the gap filling sealant substantially matches the visual appearance of the textured surface of the protective film.

5. A method according to claim 1, wherein the gap filing sealant is a settable sealant.

6. A method according to claim 1, wherein the gap filing sealant is a clear sealant.

7. A method according to claim 1, wherein the gap filing sealant has a cloudy appearance.

8. A method according to claim 1, including attaching at least one of the first and second wall panels to the wall by double-sided adhesive tape or film.

9. A method according to claim 8, including applying double-sided adhesive tape or film to the wall; and wherein mounting the first and second wall panels to the wall includes mounting a peripheral portion of the first wall panel onto the double-sided adhesive tape or film; mounting a peripheral portion of the second wall panel onto the double-sided adhesive tape of film, such that the peripheral portions are located adjacent to one another.

10. A method according to claim 1, including bonding a backing member to the wall, wherein the boding member is arranged to support at least one of the first and second wall panels on the wall.

11. A method according to claim 10, including applying double-sided adhesive tape or film to at least one of the backing member and the wall panel.

12. A method according to claim 11, wherein mounting the first and second wall panels to the wall includes mounting a peripheral portion of the first wall panel onto the double-sided adhesive tape or film; mounting a peripheral portion of the second wall panel onto the double-sided adhesive tape of film, such that the peripheral portions are located adjacent to one another.

13. A method according to claim 1, wherein at least one of the wall panels is transported to an installation site in a rolled up configuration, and including unrolling the wall panel prior to mounting on the wall.

14. A method according to claim 1, wherein the thickness of the substrate for at least one of the first and second wall panels is greater than or equal to 1 mm; and/or the thickness of the substrate for at least one of the first and second wall panels is less than or equal to 2 mm.

15. A method according to claim 1, wherein the film includes a plasticizer content which is greater than or equal to 15%; and/or the film includes a plasticizer content which is less than or equal to 25%.

16. A method according to claim 1, wherein the film has a density in the range 1.25 g/cm³ to 1.35 g/cm³.

17. A method according to claim 1, wherein the film is attached to the wall panel by means of: a pressure sensitive adhesive, such as a solvent acrylic adhesive; or heat during extrusion of the substrate.

18. A method according to claim 1, wherein the film has a pre-textured thickness which is greater than or equal to 120 μm; and/or the film has pre-textured thickness which is less than or equal to 200 μm.

19. A method according to claim 1, wherein the height of the texture is greater or equal to 15 μm; and/or less than or equal to 80 μm.

20. A method according to claim 1, wherein the average surface roughness of the textured surface is greater than or equal to 2 μm; and/or is less than or equal to 12 μm.

21. A method according to claim 1, wherein the surface gloss measurement of the textured surface is greater than or equal to 1GU and/or is less than or equal to 20GU.

22. A method according to claim 1, wherein the film includes a thermoplastic such as at least one of PVC, PMMA and PVDF.

23. A method according to claim 1, wherein the film comprises a PVC film, and preferably a monomeric calendared PVC film.

24. A method according to claim 1, wherein at least one of the wall panels includes a printed image.

25. A method according to claim 24, wherein at least one image is printed on to at least one of: the film; the substrate; and an intermediate layer such as an adhesive layer.

26. A method according to claim 1, wherein the substrate for at least one of the first and second wall panels includes a thermoplastic, such as at least one of PVC and ABS.

27. A wall panel system including: at least first and second laminated wall panels, each having a thermoplastics substrate and a transparent protective film applied over a major surface of the substrate, said protective film including a textured surface; and a gap filling sealant for filling a gap between adjacent peripheral portions of the first and second wall panels; wherein the textured surface of the protective film includes a multiplicity of micro-peaks and/or micro-troughs randomly arranged, thereby providing a light diffusing and/or light scattering effect.

28. A system according to according to claim 27, wherein each wall panel is arranged according to the wall panels used in the method of claim 1.
